(19) United States
(12) Patent Application Publication
(10) Pub. No.: US 2026/0093902 A1
(43) Pub. Date: Apr. 2, 2026

(54) SYSTEM FOR IMAGE ACQUISITION, ANNOTATION, AND USE

(71) Applicant: FMV Innovations LLC, Savannah, GA (US)

(72) Inventor: Richard E. Voight, Charleston, SC (US)

(73) Assignee: FMV Innovations LLC, Savannah, GA (US)

(21) Appl. No.: 19/344,761

(22) Filed: Sep. 30, 2025

Related U.S. Application Data
(60) Provisional application No. 63/701,654, filed on Oct. 1, 2024.

(51) Int. Cl. G06F 40/169; G06F 3/04845; G06F 3/0488; G10L 15/26

(52) U.S. Cl. CPC G06F 40/169; G06F 3/04845; G06F 3/0488; G10L 15/26

(57) ABSTRACT

A method for image management provides a scanner or other input device that is in signal communication with a processor and is configured to acquire image content in a digital file format and to store the digital file on the processor. The method repeats a sequence of image acquisition, display, response to image conditioning instructions, and annotation. The image content displays for operator review, provides a utility for restoring image appearance and accepting operator instructions for image conditioning, and replacing the stored digital file with a restored digital image file, records and links audible annotation related to the restored image file, and stores restored image files and linked recorded audible annotations as a story data structure that is accessible from the processor. The restored image files are rendered onto the display and the audible annotation directed to a speaker.

### CROSS REFERENCE TO RELATED APPLICATIONS

Reference is made to, and priority is claimed from, commonly assigned U.S. Ser. No. 63/701,654 filed as a provisional patent application on 1 Oct. 2024, entitled “SYSTEM FOR IMAGE ACQUISITION, ANNOTATION, AND USE” in the name of Richard E. Voight, incorporated herein in its entirety.

### FIELD OF THE INVENTION

The present application is directed to system and apparatus for management, restoration, and storage of image content with associated audio annotation. More particularly, the application is directed to a system that allows images to be acquired, conditioned, and organized in a sequence configured for later recall and use.

### BACKGROUND OF THE INVENTION

Image album generation has become a popular pastime, enabling people to better organize and store photographic images and other documentary content that can have significant meaning for a family or other group. This activity allows a family member or organization staff member to provide an orderly mechanism for preserving images in ways that can be largely self-explanatory, allowing the viewer to browse through recorded image data and relate them to an historical context. There is significant research and study related to the use of images to help remediate memory loss, such as due to ageing, for example.

Among shortcomings of conventional solutions for image archival are lack of computer and software tools that streamline the workflow and allow the user to store images and related content in a manner that allows straightforward retrieval and use. Verbal descriptions recounting the subject of the photo and related events must be stored separately and can be difficult to maintain and can be easily lost. Conventional solutions are not designed for those unfamiliar with computer systems and require the user to arrange and manage image and audio content without utilities that can be easy to understand and use. Moreover, conventional workflows and systems can provide imposing barriers to users who may be physically challenged due to illness or various chronic conditions.

Scanner manufacturers, for example, provide software that can be helpful for general needs, such as single-scan operation, in which a single image is formed containing all of the images or documents currently on the scanner platen or other scanned surface. However, conventional scan software is directed more to technical solutions and to a technology-oriented audience than to older adults or those without computer technology skills. Obtaining individual images from a scan can require using specialized software utilities not available from the scanner manufacturer.

Separate scanning utilities and image editing tools are not integrated, requiring the user to become expert in the use of different software programs and to manually track and link together files from various sources. Little or no attention has been paid to providing an intuitive workflow for preserving photos and scanned images in a user-friendly format.

Further, for many imaging applications, audio narration can be helpful for navigating and appreciating the recorded image content. But conventional systems fail to link audio content to the stored image for easy retrieval and use, requiring the user to construct and maintain a customized database of linked filed of different types.

Thus, it can be appreciated that there is a need for an integrated image scanning, restoration, storage, and use solution that allows straightforward use and provides improved image quality for scanned photos from numerous sources.

### SUMMARY OF THE INVENTION

An object of the present disclosure is to address the need for a convenient solution that allows acquisition, restoration, organization, annotation, and recall of images from a single system.

According to one aspect of the disclosure, there is provided a system for image management comprising:
providing a scanner or other input device that is in signal communication with a processor and is configured to acquire image content in a digital file format and to store the digital file on the processor;
repeating, one or more times, a sequence of:
(i) acquiring image content from the scanner or other input device;
(ii) displaying the acquired image content for operator review;
(iii) responding to operator instructions for conditioning appearance of the acquired image content and replacing the stored digital file with a restored digital image file; and
(iv) acquiring one or both text and audible annotation related to the restored image file and linking the acquired annotation to the restored digital image file;
storing a plurality of restored image files and their corresponding linked recorded audible annotations in an ordered sequence to form a story data structure that is accessible from the processor;
and
rendering the restored image files of the story data structure onto the display and directing the audible annotation to a speaker that is in signal communication with the processor.

The system can further provide utilities for transcribing voice narration to text that can be edited and accessed using search tools. The text annotation is similarly stored along with the image and can be stored as part of the story data structure.

### BRIEF DESCRIPTION OF DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 is a schematic diagram showing an image acquisition and organization system according to an embodiment of the present disclosure.

FIG. 2 is a flow diagram showing a sequence of steps operator steps that can be used for forming a story using the system of FIG. 1.

FIG. 3 is a perspective view of a scanner configuration that can be particularly suited for use with the Applicant system.

FIG. 4A shows an entry screen prompting the user to edit and improve the acquired image content or to record audio to accompany the image.

FIG. 4B shows screen options for user selection of image restoration utilities.

FIG. 4C shows a screen for user editing.

FIG. 4D shows a screen with various utilities for image adjustment and restoration.

FIG. 4E shows a screen showing tools for textual annotation of images.

FIG. 4F shows a screen that displays transcription for audible text, prepared and stored as image metadata.

FIG. 5 is a schematic diagram that shows features for storing and recalling display and audio content for a story, scripted and annotated according to an embodiment of the present disclosure.

FIG. 6 is a block diagram showing a logic flow sequence for story generation related to memory.

FIG. 7 is an alternate block diagram showing a logic flow sequence for story generation related to memory.

### DETAILED DESCRIPTION OF THE INVENTION

The following is a detailed description of exemplary embodiments, reference being made to the drawings in which the same reference numerals identify the same elements of structure in each of the several figures.

Where they are used in the context of the present disclosure, the terms “first”, “second”, and so on, do not necessarily denote any ordinal, sequential, or priority relation, but are simply used to more clearly distinguish one step, element, or set of elements from another, unless specified otherwise.

In the context of the present disclosure, the term “energizable” describes a component or device that is enabled to perform a function upon receiving power and, optionally, upon also receiving an enabling signal.

The term “actuable” has its conventional meaning, relating to a device or component that is capable of effecting an action in response to a stimulus, such as in response to an electrical signal, for example.

In the context of the present disclosure, the term “coupled” is intended to indicate a mechanical association, connection, relation, or linking, between two or more components, such that the disposition of one component affects the spatial disposition of a component to which it is coupled. For mechanical coupling, two components need not be in direct contact, but can be linked through one or more intermediary components.

The general term “scanner” relates to an optical apparatus that is energizable to acquire two-dimensional image data content from various sources, including photos, printed materials, or other objects.

The term “in signal communication” as used in the application means that two or more devices and/or components are capable of communicating with each other in at least one direction via signals that travel over some type of signal path. Signal communication can be wireless. The term “event” is used herein to indicate an action that causes a signal to be generated, such as an operator press of a scanner button, for example.

The term “highlighting” for a displayed feature has its conventional meaning as is understood to those skilled in the information and image display arts. In general, highlighting uses some form of localized display enhancement to attract the visual attention of the viewer. Highlighting a portion of an image, for example, can be achieved in any of a number of ways, including, but not limited to, annotating, displaying a nearby or overlaying symbol, outlining or tracing, display in a different color or at a markedly different intensity, color saturation, or gray scale value than other image or information content, blinking or animation of a portion of a display, or display at higher sharpness or contrast.

The term “set”, as used herein, refers to a non-empty set, as the concept of a collection of elements or members of a set is widely understood in elementary mathematics. The term “subset”, unless otherwise explicitly stated, is used herein to refer to a non-empty proper subset, that is, to a subset of the larger set, having one or more members. For a set Q, a subset may comprise the complete set Q. A “proper subset” of set Q, however, is strictly contained in set Q and excludes at least one member of set Q.

Image data handled and stored by the Applicant system, generally termed “images” in the context of the present disclosure, can be acquired from any of a number of sources that represent visual images in a data format. Image content can be obtained, for example, from online sources, from a computer, from a digital camera that provides images directly in digital format, or from a scanner that is configured to generate a digital image file by scanning an image, typically using a raster scanning pattern that obtains line-by-line image data. Image data files can be acquired directly from the scanner or digital camera device, smart phone, or digital tablet, or can be obtained from a portable memory device, such as a USB flash memory device, for example, or from the internet or other networked source. Images stored and used in this system can be “still” images such as photographs or smart phone images, or can be video images or clips.

Using the Applicant solution for the tasks of storing and retrieval of image content with related metadata, a series of images can be provided as a presentable package or “story”, with images ordered in a sequence (scripted) and incorporating annotation and other accompaniment or effects. The story metaphor can be particularly apt for types of digital scrapbooking, for example, in which family photos are incorporated with audio clips such as comments, interviews, and recorded sessions. Other types of packaging and presentation can be employed to organize images and records for historical archival, for example. Audio commentary can be added and edited to accompany the images at the time the story is first generated or later, including when the story is viewed.

In addition to digital storage and presentation, the Applicant solution also provides the option for generating printed materials using stored images and their corresponding metadata. This aspect has been found useful as an additional aid in memory loss remediation, for example.

### System Hardware

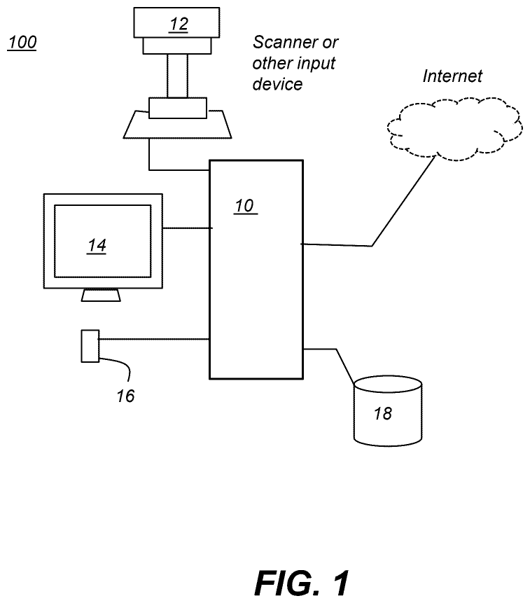

The overall Applicant solution can apply to any of a number of embodiments that have at least the minimal components needed for collecting and organizing image contents with added audio and other annotation utilities. The schematic diagram of FIG. 1 shows an image acquisition and organization system 100 according to an embodiment of the present disclosure. Software that executes on a control logic processor or CPU (control processing unit) 10 can interface with a scanner 12 that is configured to acquire and generate image content from a scanned object, such as a photo, printed page, document, or various types of 3-dimensional objects, such as jewelry, plaques, military medals, or personal items, for example. Alternately, image content can be obtained from any of various input/output devices 16, such as a personal memory device, including a USB flash disk or other drive, or from a smart phone, web site, or other online content. Data memory and storage for acquired input images, as well as for processed story content, can be provided within CPU 10 or on a separate memory 18 or using an online or “cloud” storage utility, for example.

According to an embodiment of the present disclosure, CPU 10 includes software that executes database management, using SQL (Structured Query Language) or other database storage mechanism, image metadata linked to image content, and related tools that handle and organize storage of the saved images and audio and allow search capabilities for obtaining images that relate to various people or topics.

A display 14 can provide operator interface screens for guiding the user, obtaining user instructions and command entry. In addition, display 14 can also serve in image restoration, allowing display and selection of various image conditioning utilities that can be applied to the image content, as described in more detail subsequently. Display 14 can also be used for image access and rendering and story presentation, as well as serving as the user interface vehicle for subsequent addition to, and refinement of, the story as generated, and for organizing and ordering online and published tools that relate to stored image content.

Other input/output devices 16 can include a microphone, headphones, or other type of audio input or output component, for example.

For a user-friendly system, integration and use of scanner 12 can be of special importance, allowing the user to more readily use and adapt the system for particular needs and situations. According to an embodiment of the present disclosure, a free-standing scanner, without a fixed platen, can be used. An exemplary scanner for this purpose can be the ScanSnap SV600 Large Format Contactless Scanner manufactured by Ricoh. This type of scanner can handle acquisition of multiple photo formats and flat documents and includes some capability for scanning books, journals, notebooks, and objects that may not provide a planar surface for imaging on a flat-bed scanner. Other types of compatible scanners can be used, including standalone scanners from Epson, Canon, Brother, HP, and other manufacturers as well as scanners integrated into various configurations of “all-in-one” printers and similar general-purpose scanner devices.

Processor 10 can be a dedicated CPU or other programmable control logic processor device. A laptop or desktop computer can execute the software and provide the interfacing needed for the Applicant solution, without special requirements for additional memory, increased processor speed, or special-purpose interface connections. A software application or “app” that executes on a smartphone, tablet, or web-based application can alternately be used for system control and acquisition and for executing storage and display software.

### Workflow Sequence

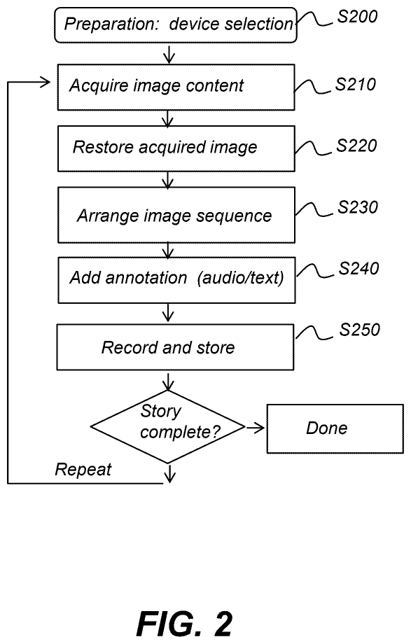

Embodiments of the present disclosure organize images and related metadata in a data structure that is termed a story in the context of the present disclosure; alternately, image and metadata components can be packaged as a composite memory entity. By utilizing industry metadata standards, portability and transferability within the embodiment file and data structure is flexible with other applications. The logic flow diagram of FIG. 2 shows a sequence of operator steps that can be used for forming a story using system 100 of FIG. 1. Each of the general steps shown in FIG. 2 allows a number of alternative embodiments, including those described in more detail subsequently. It should also be noted that the sequence shown in FIG. 2 is not fixed as to order; variations on this sequence and alternate entry points to story generation can also be practiced. Machine learning can be applied for story generation, such as for steps used to edit, organize, and annotate images, for example. The system can be trained to follow a learned pattern for a new story or subject person, using training data acquired from an existing set of stories.

Key elements in forming the story include the still and video images that are arranged and organized in some pattern by the user. Following the general sequence of FIG. 2, the operator selects a scanner device or makes some other command entries on a device screen or by pressing a control button that activates story formation software in a preparation step S200. The user acquires the image content in an acquisition step S210, using a selected image source, either scanner 12, a smartphone, or some other source, such as an input device 16, or acquired online or from a stored digital image available on, or previously stored and accessible through, processor 10.

In a restoration step S220, the acquired image content displays to the user for verification and for optional image cleanup and/or editing. A number of image restoration utilities can be available to the user for suitable presentation of the image, including both automated and user-manipulated image adjustment tools, such as those described in more detail subsequently.

A sequencing step S230 can allow the user to re-arrange the image order or to adjust the pattern of the displayed content on the display 14, for example. As with other steps in the general sequence of FIG. 2, sequencing step S230 provides utilities that can be used to form and improve the story at any time in the preparation process.

In an annotation step S240, the user has a number of options for adding textual or audible annotation to the story, associated with individual images or with the particular sequence that is used. According to an embodiment of the present disclosure, a user can add audio commentary, for example, during and following image acquisition in step S210 or restoration in step S220, or as needed during sequencing step S230. Audio content can be linked to the images and to the image sequence and timing, as described in more detail subsequently.

A recording step S250 can also be executed at any suitable interval as the story is formed, allowing the user to save work that is in process for return at a later time or to save a “snapshot” of work completed to date.

As is shown in FIG. 2, the basic steps for forming a story can be repeated as many times as needed, adding or deleting image content or display duration or changing position and sequencing of content serially in the same work session or at later times. The story can be accessed as content in a known file format, or can be a specialized file format that is labeled to identify its scripted and/or free-flowing, reminiscent content.

### Image Acquisition

The Applicant solution can include features that help to simplify the user effort required for image acquisition. The scanning sequence described with reference to FIG. 2 allows repeated scanning of image content, such as might be accomplished in working through a family photo album or paging through and scanning letters, books, or other documents so that they can be presented in an intended sequence, along with suitable non-image content such as audio or text annotation. Image content can also be obtained from smartphone or online sources and can be intermixed in any order suited to the purpose(s) of the intended presentation. The user has the capability to adjust the sequence, timing, and presentation while editing or at a later time.

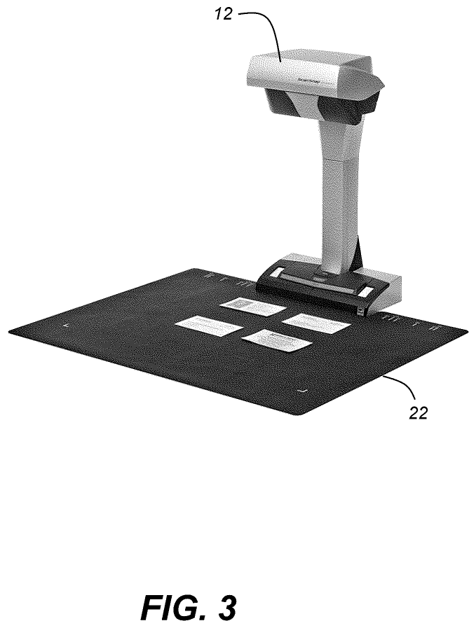

The perspective view of FIG. 3 shows a scanner configuration that can be particularly suited for use with the Applicant system. Configured in a pedestal arrangement and positioned against a portable platen 22, scanner 12 operates by directing a line of light over the platen area; the moving line of light is projected onto that portion of the visual field that is currently within the field of view of scanner optics.

Scanner 12 in FIG. 3 can include an optional page-turning device that automatically advances through a document, scanning each page in succession. Among features of high-end devices of this type are improved measurement and response scan systems for automatic flattening of the scanned book, journal, or photo album and other features. According to an embodiment of the present disclosure, the scanner can generate a standard file, such as a .pdf, jpeg, or TIFF file. The scanner output can also include a text file obtained from a scanned document using optical character recognition (OCR).

Scanner 12 can alternately be used to acquire multiple images at the same time, as shown in FIG. 3, allowing the user to populate the scan platen with several images at the same time, and yet allow individual editing and handling of each image in assembling the story. According to one embodiment of the present disclosure, as many as 10 images can be scanned, with scanner or system software separating and straightening the alignment of images in the same scan pass. The applicant system of FIG. 1 can further control scanner 12 operation for setup options and scan settings, such as brightness and contrast, resolution (where adjustable), adjustment of monochromatic or color content, file type(s) generated, and other operational parameters.

Once the image content is scanned, processor 10 can assign a file name to individually scanned images or to any collection of acquired images, which can be indicated for reference on a subsequent processing display.

The scanner can also scan 3D objects in 2D. Thus, for example, medals, awards, small objects and keepsakes can be scanned for inclusion in a prepared presentation or story.

### Image Editing and Restoration

In many cases, particularly for records archival and for storing historical information, such as family photos and records, scanned image quality may be disappointing because of the condition of the documents themselves. Photos, for example, can be faded, color fidelity can be compromised, particularly with age or frequent handling, sharpness, contrast, or brightness adjustment might be useful. Cropping can help to isolate subjects of more interest. The Applicant image acquisition and organization system 100 can provide a number of features for image restoration, suitable for conditioning images to improve color or monochrome content.

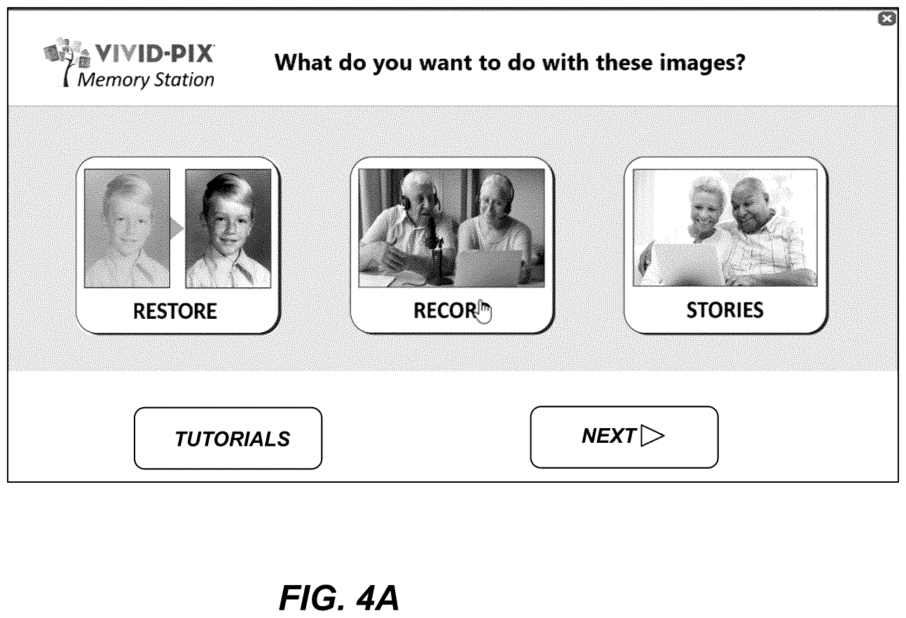

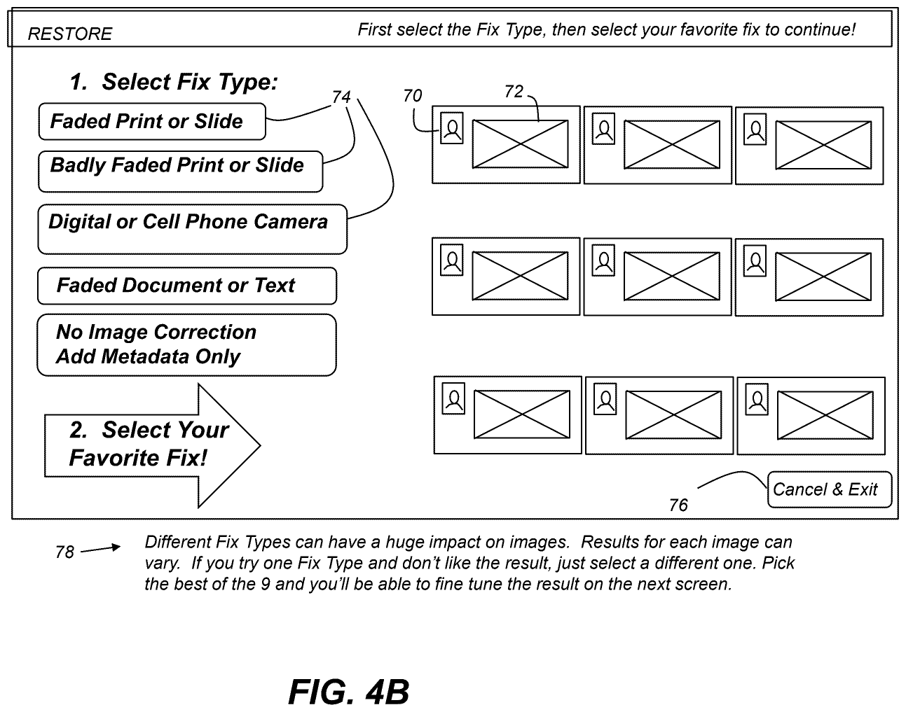

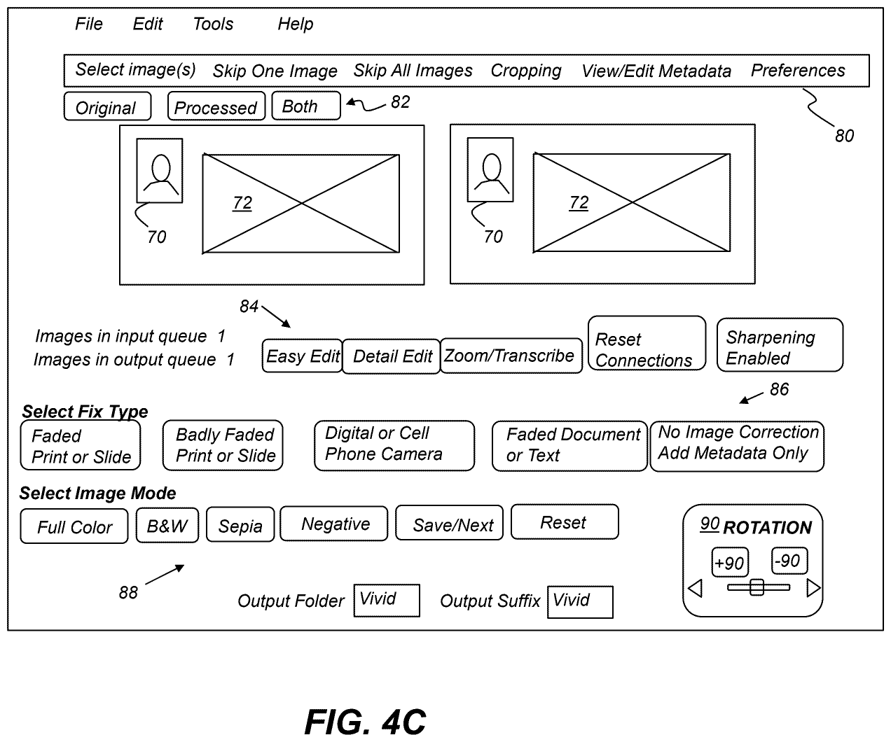

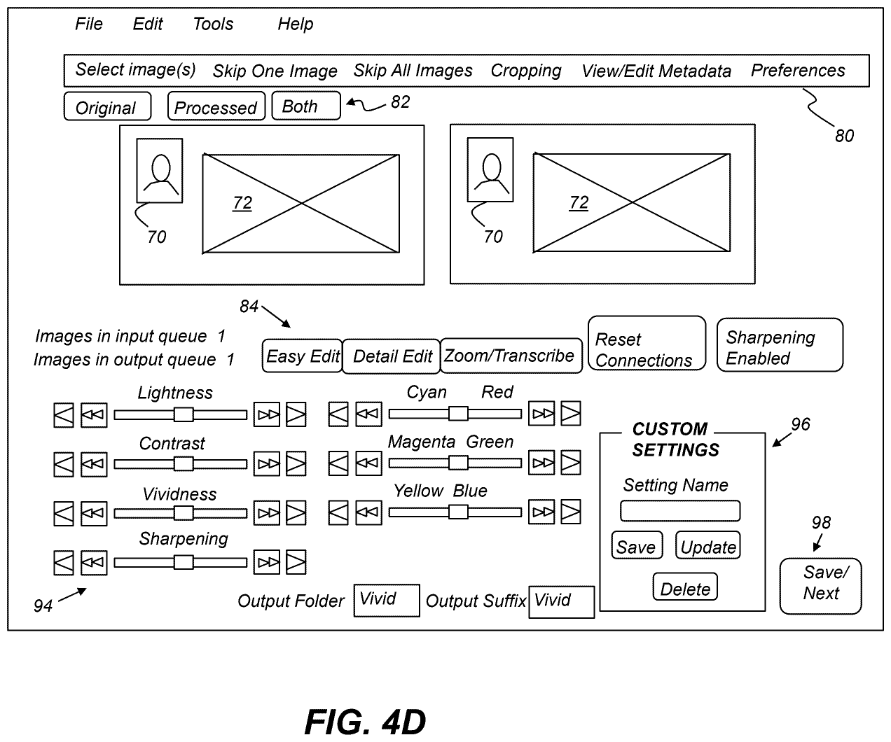

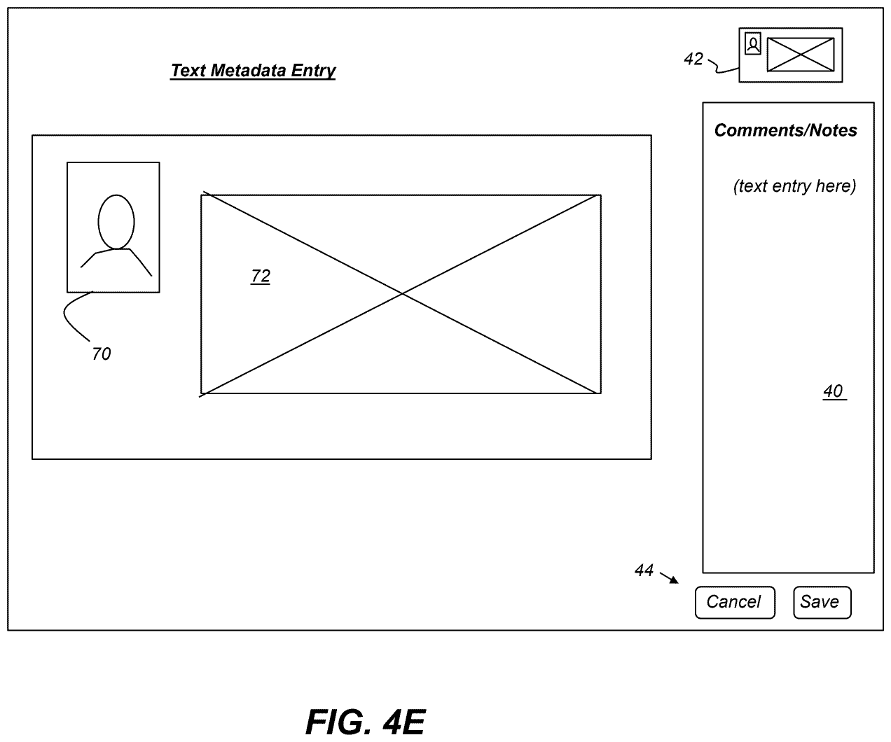

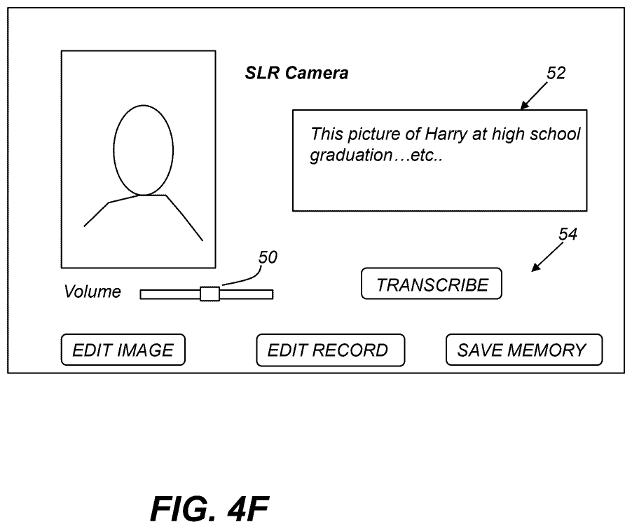

Following image acquisition steps using the scanner 12 or other input, the system can prompt the user to restore the image quality of the obtained content, using a prompt display as shown in FIG. 4A. If the user chooses to restore images, selection of Restore capability, such as selection using a mouse or touch screen, can initiate a number of image conditioning operations for improving image appearance. As an initial step in restoration, the user can select the type of utility needed for image conditioning, as shown in the example of FIG. 4B.

FIG. 4B shows a schematic of a display screen layout. The same image 70, with included text content 72, stored in image or text format, can display in multiple versions, each version showing different treatment. In this way, image content can be presented to the viewer automatically, with a representative display given for approval and visual suggestion for optional restoration. A number of selection buttons 74 can be provided, listing different restoration options for image conditioning based on image source or overall condition. As shown in the FIG. 4B example, the operator can select tools for conditioning images having faded or badly faded image content, enabling utilities intended more specifically for older photographs, for example. Other buttons 74 can be provided for adjusting image content according to image source, more suitable for digital or smart phone image conditioning, for example. An array of representative image treatments can be shown, giving the user a number of optional standard treatments or starting-points for subsequent adjustment, to improve image quality or to provide the image content in a more standardized format, so that images from different sources can have compatible treatment. The Applicant software can retain knowledge of original image condition and restoration settings, so that automatic correction that has been fine-tuned to individual preferences can be saved and re-used for subsequent images. Images and settings used for image conditioning can be used to form a training set to guide machine learning, using techniques familiar to those skilled in artificial intelligence (AI).

For example, images obtained in the same scan can be presented sequentially for review and editing. Thus, for example, where two or more images are acquired in the same scan, the system can identify individual images and display, sequentially, each image for user viewing and restoration conditioning.

According to an embodiment, user selection of a particular image conditioning utility can include utilities that help to correct image fading. Fading can relate to image content or to text content, with different treatments appropriately applied. In the example of FIG. 4B, system software automatically modifies the scanned image at various levels or thresholds, allowing user selection of the most pleasing results from this automated image conditioning. A cancel or exit button 76 can enable the user to proceed or to exit to other treatment options. Explanatory screen text 78 can be provided to help with user navigation of the screens and utilities for image conditioning and restoration.

FIG. 4C shows an exemplary display screen for the RESTORE function for image conditioning, selected on the screen of FIG. 4A. The set of controls on this screen give the user the capability to examine image content more closely as editing takes place. A menu selection 80 allows the user to select or skip images for edit functions, perform cropping, view image metadata and set various preferences for image editing and restoration. Image 70 and text 72 content can be viewed as shown using control buttons 82 to show this content before and after restoration editing. Control buttons 84 can allow a number of editing functions for image conditioning, with an automatic set of easy edits, detailed editing parameters, zoom and transcribe functions, image reset and sharpening utilities. Control buttons 86 can enable selection of the type of editing fixes needed, including those for faded or badly faded images, standard digital or cell phone images, faded document or text, or metadata only selections. Control buttons 88 may allow selection of an image mode, such as full color, monochrome, sepia, and negative formats. Save and reset functions may also be provided. Cropping can also be provided. Cropping can be either free-form or may use commonly employed aspect ratios, such as aspect ratios conventionally employed for photographs and reprints, for example.

A set of rotation controls 90 is also available on the display screen of FIG. 4C, allowing rotation to fixed or variable angles. Rotation can be full 90 degrees clockwise or counter-clockwise rotation, or can be incremental, such as through a set of fixed values, for example. A variable zoom function can also be available.

As shown in the screen layout of FIG. 4D, the user also has the option of selecting a detail edit function that provides further conditioning, including control of color balance, sharpening, brightness, contrast, and other image characteristics. In addition to manual adjustment using on-screen color controls 94, the user interface can allow access to one or more preset settings configurations, previously set up the by user and stored on the system. A set of setting controls 96 can be provided for settings management. Presets can be particularly useful for image conditioning, for example, where multiple images are from the same source, such as when scanning public records or photographs obtained using the same equipment setup, for example. Software-generated automatic correction can also be selected.

The user has the option to reset any image edits or corrections, restoring the image by reversing previous edits. Reset can apply for each incremental change or for returning to the original image as scanned. The original scan data can be retained to allow future editing. A save/next button 98 exits the screen functions of FIG. 4D. According to an embodiment of the present disclosure, the original image can be retained and must be deliberately removed, in conformance with archival standards, such as those applied by the Library of Congress and other standards.

Custom settings and presets can be stored for the system or for particular image conditioning functions, such as for image restoration. As the user adjusts images to a more acceptable non-faded or monochromatic improved state, the user can save settings, such as settings related to color balance, brightness, sharpness, and other image characteristics, to apply the same image conditioning steps automatically to other images that are processed through the workflow. These custom settings can be retained within the program for future use. As one example, preset custom fields for portrait photography can be professionally provided and stored within the program as “presets.” Additionally, adjustments previously used can be applied automatically to subsequent images of the same type or in the same editing session, with possible override by the viewer.

### Text Annotation

A transcribe function can enable the user to add text annotation that can display or be accessed using the corresponding acquired image. FIG. 4E shows a screen display with a side panel 40 allowing text entry, which appears at the right side of the screen in this embodiment. The balance of the screen display can also show the corresponding image for the text annotation, as a thumbnail image 42 or at full size. Control buttons 44 may be provided for cancel, save, or exit functions. Transcription tools can include utilities that automatically transcribe recorded audio, as described subsequently.

Facial and object recognition can be provided, with results stored as part of text annotation for the image. For stored document images, optical character recognition (OCR) can be available on the system, with text results stored as text annotation and thus searchable using database search tools, for example.

### Audio Annotation

Once the image has been acquired, and before, during, or after image restoration processing, if any, the user can have the option to record audio content that is associated to one or more images. According to an embodiment, as part of a story structure, audio annotation is recorded to accompany a set of related images, intended for presentation in a sequence, in synchronization with replay of the recorded audio.

The audio content can be associated with the image, wherever the image is used, or it can be linked to a succession of images in the story structure described subsequently. Thus, different audio content can be associated with the same image, depending on how the recorded image content is presented. Multiple audio files can be associated with the same image, such as audio from different family members or friends, for example.

For example, audio content can be recorded while the user pages through a sequence of images. Alternately, images can be attached to alternate audio content, including music, for example, that was recorded separately.

According to an embodiment, the system includes a voice-to-text transcription capability. Using this, voice memory capture can be transcribed to text so that it is editable, searchable within the software and by other computers and websites, and stored with the image aligned with Metadata standards. Voice can also be learned and understood through trained machine logic or AI (Artificial Intelligence) to allow the audio content to be used to help reduce the time needed to instruct on using the software as well as to interact with others. This feature can help to reduce isolation and loneliness for those suffering from cognitive decline, for example. This feature can also be used for education.

The example screen of FIG. 4F shows transcription for audible text, prepared and stored as image metadata. Exemplary annotation 52 can display with the saved image whenever it is recalled. A volume control 50 can be provided where audio is available. Control buttons 54 enable further transcription entry or editing, image editing, editing of the overall record, including metadata, and saving the image and its audio and text metadata as a composite memory entity, stored and recalled by the system as a “memory”.

Audio content can also be used to aid user interaction with the system, such as using audio instructions for search of a database of story content. This feature can have significant benefits for users who may have difficulty in manipulating mouse or other manual pointing devices, for example.

According to an embodiment of the present disclosure, voice replacement can be implemented, substituting an automated voice or enhancing sound quality for the recorded voice. The original audio can be retained, even where editing is performed.

Data is maintained on audio content, including information such as date and time, identity of the person recording, and other information about recording environment or conditions.

### Image Recall and Presentation

According to an embodiment of the present disclosure, the same software tool that is used to acquire, store, restore, and annotate user image content, using the sequence described previously, for example, also serves for image display and presentation of the recorded memory or “story” or other sequence. The software can also be used to provide input to Large Language and Small Language Models (LLM/SLM) for various interactive purposes. User options for image presentation may include the following:
(i) Discrete image presentation, in which the viewer simply selects the image for display from a listing or directory of images, including images stored with metadata as composite memory entities. This arrangement can be most suitable for records archival, for example, where there may be some audio or textual annotation, but wherein each image or document is viewed individually.
(ii) Sequential image presentation, in which a predetermined sequence of images is presented to the viewer, using the story model, described in more detail following.

The stories that are available on the system can be accessed using the same software utility that was used to restore image quality and record audio content, as shown in FIG. 4A. Clicking the Stories selection provides a listing of the grouped image sequences that are available for replay on the system.

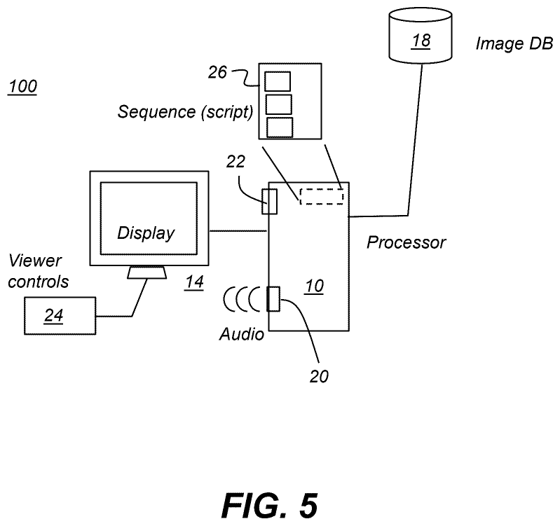

Images of the viewer while watching a story or while generating the story can also be obtained by the system processor, as a type of “selfie” image or video that can be included with or linked to the story image content. For this purpose, a camera (FIG. 5) that is in signal communication with processor 10, such as a built-in camera for example, may be actuated to acquire and store still or video images of the viewer.

Audio annotation can be played back on a speaker, headphones, ear buds, or other suitable receiver.

### Story Arrangement and Use

A particular benefit of the Applicant solution is the capability to arrange images and their associated text and/or audio annotation as a type of story structure or “script”. Referring back to the flow diagram of FIG. 2, a story structure is formed as a sequence of images along with accompanying annotation. As FIG. 2 describes, the user can arrange the sequence of images for a preferred presentation, adding audio or text annotation as needed for effectively generating a script for the displayed and audio content.

Processor 10 can store or provide access to multiple stories for recall and presentation, selectable by the viewer. A database of stories generated or acquired by the user can be maintained internal to processor 10 or part of data storage or memory 18 (FIG. 1). Stories can be maintained in original form, as well as modified and enhanced by future users. Stories can be machine-generated using input for AI (Artificial Intelligence) generated interaction with users, LLMs (Large Language Models), SLMs (Small Language Models), and devices such as robots.

In generating the story, audio and text annotation that is associated with each image is included, by default. However, the story structure also allows transitional audio or textual annotation that can be presented between images or as part of a succession of images. Music or other audio can alternately be provided to accompany the displayed sequence. Different stories can be interrelated, allowing the viewer to quickly move from one to the next according to subject, personalities, themes, time periods, events, or other characteristics.

In addition to sequence, timing of image presentation can be automatically set by the user, effectively generating a script 26. Script 26 can be from a separate utility that manages image content or can be incorporated as a structured file, such as an MP4 (ISO/IEC standard 14496-14:2003 MPEG-4) multimedia file, for example, transmitted in 2D or 3D on a screen or holographic avatar.

Permissions can be set to enable or disable visibility or presentation of a story, such as for restricting access to story content.

FIG. 5 shows components of image acquisition and organization system 100 used for story presentation according to an embodiment of the present disclosure. Viewer controls 24, which can include standard mouse and touch-screen entry tools for example, can work in conjunction with display 14 for display and menu selection. For story viewing, processor 10 executes script 26 that defines the image content to be displayed and the order of display. Audio output can be provided through display 14 or processor 10 hardware or speaker 20, as shown in FIG. 5. The viewer has the capability to pause, repeat, adjust speed, volume, brightness, and to modify image characteristics during story presentation.

Auto-segues can be sourced from historical content, including information from other stories or composite memory entities on the system as well as content obtained from the internet. Images, music, newsreel, or video image content can be automatically obtained according to learned image content from information entered by the user.

According to an embodiment of the present disclosure, the story data structure can be a series of links to appropriate images and annotation, in the order and arrangement set up in script 26 by the story originator. This structure allows the same image or images to be used in multiple stories in different ways, as well as allowing recorded audio content to be re-purposed for story content generated previously or subsequently. Different audio content can be selected for the same sequence or set of images in a story, allowing presentation of the same image content and annotation from different viewpoints, for example.

### Machine Learning Application

According to an embodiment of the present disclosure, machine learning (ML) logic or AI (Artificial Intelligence) utilities can be used to perform various functions for linking images to each other and for linking audio and text annotation to image content. AI can be used, for example, to identify the same facial features in a series of photos, including the ability to track facial changes over time, such as those due to normal ageing, for example. Story content submitted to the machine learning logic can be analyzed to link image content according to detection of individual persons, so that each picture with a particular person is identified and can be organized in a series or in different arrangements, such as based on activity or surroundings. Machine learning can also identify other individuals within an image who are similarly of interest for linking or tracking. A type of image understanding can be applied using AI, allowing related content in different stories to be identified and accessed for replay.

Machine learning logic can interact with the story originator to enter identifying information about different individuals in a photograph, for example. The machine learning logic can also be used to help generate appropriate outlines for visually highlighting a particular person in images presented. Thus, for example, the image of a person shown in FIG. 1 can be highlighted, used as an actuator to initiate the presentation of a corresponding story. When a touch screen is used, touch upon the highlighted image, or an appropriate portion thereof, can activate replay of related audio content. When a mouse is used, clicking on the highlighted image can activate this replay. Using this facility, for example, a still image can have multiple associated audio files, with selection of a particular audio file dependent on viewer selection of a corresponding highlighted figure or element in the image.

Audio content can also be linked, for example, so that different instances of the same voice or voices can be tracked and used in re-arranging content.

AI utilities can also be employed to obtain and characterize various characteristics of the image content, including date or probable date of capture, color fidelity, image condition, image source, and other parameters.

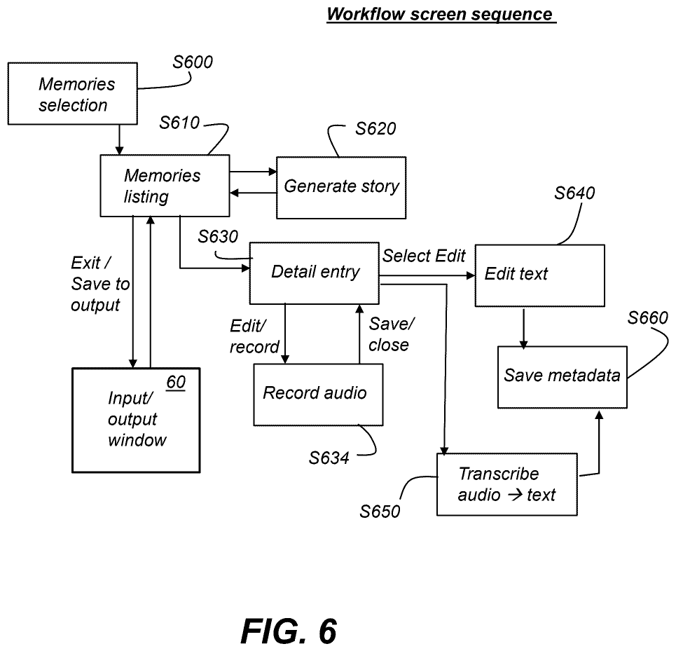

The block diagram of FIG. 6 shows a workflow logic sequence for story generation that can be used to promote interaction with the viewer, such as with a person suffering some measure of dementia or memory loss. Steps in selection and story generation can be directed to particular memories of events or persons that might be of value to the patient, enabling a customized story to be generated for presentation as part of a therapeutic regimen. A memories selection step S600 allows various imaging and linked audio content of personal interest to be selected and arranged in a listing step S610. A story generation step S620 enables the selected content from the listing to be arranged in story form. The viewer can select a particular composite memory entity or initiate display of a story sequence by touching or clicking on a person or an item on the rendered screen. The user performing setup can organize content, add new images, audio, and composite memory entities and store this content as a story data structure. Image editing and audio/text annotation can be added in a detail entry step S630, using user interface screens and utilities described previously, with audio added and/or edited using a recording step S634. A text edit step S640 allows editing of annotation entries, with transcribed or typed text linked to individual images, such as using the composite memory entity format. A transcription step S650 transforms spoken audio to text form. Once transcription is performed, the generated text can be further edited to correct spelling, add content, or highlight particular material of interest. Metadata for story content can be saved with the image content in a metadata save step S660. Access to story contents related to memory, for both editing and replay, can be provided from a single input/output window 60 on display 14.

The sequence shown in FIG. 6 can work with generating an avatar or digital manifestation related to a person or character and can be presented for self-play or for assisted use.

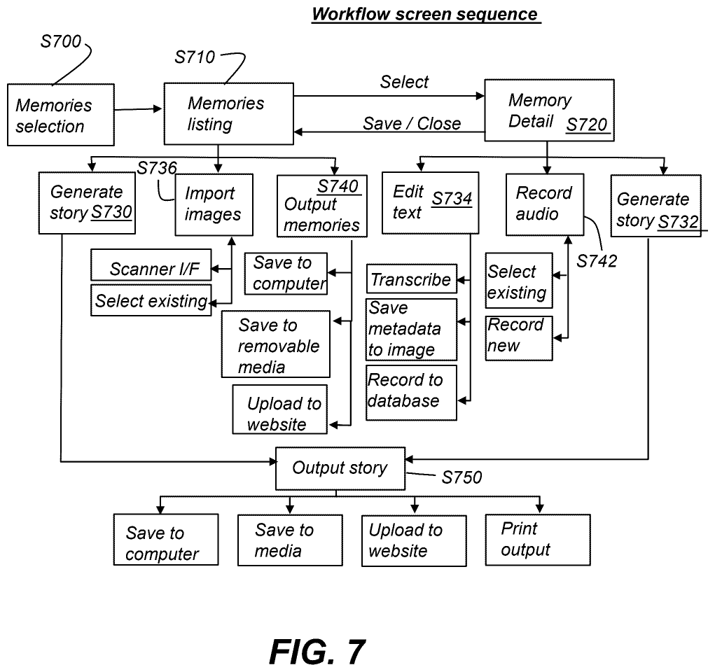

The workflow sequence of FIG. 7 shows expanded user capability for storing composite memory data according to an embodiment of the present disclosure. Memories selection step S700 allows various imaging and linked audio content of personal interest to be selected and arranged in a listing step S710. Various editing and selection tasks can be accomplished in a memory detail step S720. From the memories listing,

### Memory Card Generation

According to an embodiment of the present disclosure, a printed card output may be generated from the system, based on transcribed audio and related metadata, as a memory aid for the user. This feature can be part of the larger process of story generation and output, as described in the logic flow sequence of FIG. 7. In a memories selection step S700, a number of composite memory entities is prepared, including images and, optionally, video content, linked with audio and/or text metadata. Composite memory entities can be stored temporarily in a memories listing step S710, which can be arranged by subject, person, or other criteria. As noted previously, images, stored in an import images step S736 in the FIG. 7 sequence, can be from a number of sources, including scanned images and existing images, previously stored. A memory output step S740 saves generated memory entities can be saved to computer, removable media, or online, such as at a website or other online address. A generate story step S730 then allows the user to set up a sequence of images and related metadata as a story.

In a related workflow shown in FIG. 7, a memory detail step S720 can obtain and use composite memory entities from the memories listing for editing text in a text editing step S734 and editing or recording audio in a record audio step S742. This generated composite memory entity input can then be used in a generate story step S732, using procedures and utilities described previously.

Still continuing with the workflow shown in FIG. 7, an output story step S750 enables the generated story to be saved for subsequent computer presentation, such as on the computer, on removable media, or at a website or other accessible online storage facility. Print output can also be provided as another option.

As one print output option provided by the Applicant system, a printed card can be generated, incorporating contents of a composite memory entity for hand-held use. The Applicant has found that “Memory Cards” generated from stored composite memory entities on the Applicant system can have particular value as a memory aid tool in Photo Reminiscence Therapy (pRT).

In practical terms, Reminiscence Therapy (RT) can involve the discussion of past activities, events and experiences. Interactive discussion can be with another person, such as a trained or untrained caregiver, or with a group of people, usually with the aid of tangible prompts such as photographs, household items, and other familiar items. For this purpose, the memory card reproduces a saved image on one side and then provides story content on the reverse side. Content can include a title, an attention statement, and comments on the image content that are useful as memory aid. An exemplary memory card can be standard 5×7 inch size and on durable card stock, for example. According to an embodiment of the present disclosure, the memory card can be arranged and printed using an automated process executed by processor 10. The card can be locally printed or ordered from a separate service, for example.

Machine learning can replace decision-tree logic and be used to generate various types of prompts in order to assist in story development, thus supplementing or replacing a facilitator for story generation. Learning from varied sets of responses, machine learning can be applied to identify topics, characters, or events that are of particular interest for a user, and direct suitable audio or visual prompts intended to aid in memory recall. For example, the machine learning logic can be directed to track and respond to speech or physiological changes, such as speech rate, coherence, or volume, for example. These changes by the user can indicate excitement or interest. In response, the system logic can then direct stimulating prompts, audio, or image content in order to encourage further input from the user. Machine logic can also be trained to detect when discussion of topics has been completed and new topics introduced to initiate other prompts for continuing recording on related or other topics. Fine-tuning of machine learning can detect when conversation and recording can be redirected to other topics in order to maintain further interest from the user.

### User Interaction

The system can operate with a touch screen, mouse, or other interface that allows the user to more intuitively enter instructions or responses related to image content. The story generator can identify individuals to be highlighted on the display for linking of audio content or for linking to other story sequences that include the individual. Using this capability, for example, voice recording from an individual in an image can be entered or played back after user interaction such as clicking on a highlighted portion of the image or, where a touch screen is used, touching the image over the face of the individual. Similarly, audio related to an image object can be recorded and played back based on touch of the screen, mouse, click, or other interface device use at an appropriate position. For the viewer, touching an image of a person, such as touching the person's face, can initiate presentation of a story sequence or can initiate display of a composite memory entity.

The operator has the optional capability to set timing for each image presentation, setting the duration during which each image displays in presentation of the story, as well as the time interval between displayed images. Various types of fades can be provided by the system for transitions from one image to the next. Branching can also be provided, wherein a first story can link to a second story, either for sequential play, or to allow the viewer to divert from the main script sequence to a sub-sequence that may show additional images and present other audio content, such as content related to an event in the main script. The user can designate various prompts for offering alternate presentation sequences and image series. Further, as there are numerous types of dementia, story creation and storytelling can be suitably customized, and potential anxiety-creating events can be avoided. Conversely, helpful story creation, storytelling, and enjoyable stories can be created based upon specific types of dementia and can be individualized based upon interactions and storage of these interactions with an individual.

Permissions and management can be determined by the generator of the story. The Applicant particular notes that use of individual and combined images and stories as described hereinabove can be used to prescribe non-pharmacological imagery that can help to combat dementia, reduce anxiety, and improve connectedness and sociability in a therapeutic setting.

The invention has been described in detail, and may have been described with particular reference to a suitable or presently preferred embodiment, but it will be understood that variations and modifications can be brought about within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

1. A method for image management comprising:
providing a scanner or other input device that is in signal communication with a processor and is configured to acquire image content in a digital file format and to store the digital file on the processor;
repeating, one or more times, a sequence of:
(i) acquiring image content from the scanner or other input device;
(ii) displaying the acquired image content for operator review;
(iii) responding to operator instructions for conditioning appearance of the acquired image content and replacing the acquired digital file with a restored digital image file; and
(iv) acquiring either or both text and audible annotation related to the restored image file and linking the acquired annotation to the restored digital image file;
storing a plurality of restored image files and their corresponding linked recorded audible annotations in an ordered sequence to form a story data structure that is accessible for presentation from the processor;
and
rendering the restored image files of the story data structure onto the display and directing the audible annotation to a speaker that is in signal communication with the processor.

2. The method of claim 1 wherein the processor is configured to store the restored digital image file in an internal or external database.

3. The method of claim 1 wherein the audible annotation comprises voice audio.

4. The method of claim 1 wherein acquiring text annotation comprises using a transcription utility that transcribes text from recorded audio content.

5. The method of claim 1 wherein the operator instructions condition one or more of image brightness, contrast, or color saturation.

6. The method of claim 1 wherein presentation of story data content is initiated by user selection on an element of a rendered image.

7. The method of claim 6 wherein the user selection is made on a touch screen.

8. A method for image management comprising:
acquiring digital data for an image from a scanner;
rendering the acquired digital image data to a display;
modifying color characteristics of the acquired image data according to one or more viewer instructions to form a conditioned image;
recording audio signal content relating to the conditioned image;
recording text data relating to the conditioned image;
linking the recorded audio signal content and text data to the conditioned image;
storing, in a digital memory, the conditioned image, recorded audio signal content, and recorded text data;
and
responding to viewer interaction to render the conditioned image on the display and re-playing or editing the recorded audio content linked to the conditioned image.

9. The method of claim 8 further comprising forming a story data structure that replays a sequence of conditioned images and recorded audio signal content.

10. The method of claim 8 wherein the audio signal content is separately obtained from two or more people.

11. The method of claim 8 wherein the text data is typed on a keyboard.

12. A method for image management comprising:
providing a scanner that is in signal communication with a processor and is configured to acquire image content in a digital file format and to store the digital file on the processor;
displaying the image content for operator review;
providing a utility for restoring image appearance and accepting operator instructions for image conditioning, and replacing the stored digital file with a restored digital image file;
recording and linking audible annotation related to the restored image file;
storing a plurality of restored image files and linked recorded audible annotations in a sequence to form a story data structure that is accessible from the processor;
rendering the restored image files of the story data structure onto the display and directing the audible annotation to a speaker; and
processing the story data structure using machine learning logic to obtain metadata related to the story.

13. The method of claim 12 further comprising using machine learning to generate at least a portion of the story content.

14. The method of claim 12 wherein rendering the restored image files onto the display further comprises rendering the image files onto a touch screen display, highlighting an object within the image content, and responding to touch contact on the highlighted object by playing back recorded audio content related to the object.

15. The method of claim 14 wherein the object is a person.

16. The method of claim 14 further comprising substituting audio voice content with automated voice content.

17. The method of claim 14 wherein providing a utility for restoring image appearance comprises providing preset image modifications as default settings.

18. The method of claim 12 further comprising using machine learning for restoring image appearance.
